(19) United States
(12) Patent Application Publication
(10) Pub. No.: US 2021/0217330 A1
(43) Pub. Date: Jul. 15, 2021

(54) ADJUSTABLE AND CONFIGURABLE MOUNT

(71) Applicant: Triangle Brass Manufacturing Company, Inc., Los Angeles, CA (US)

(72) Inventor: Curtis Patrick Odom, Vista, CA (US)

(73) Assignee: Triangle Brass Manufacturing Company, Inc., Los Angeles, CA (US)

(21) Appl. No.: 16/739,271

(22) Filed: Jan. 10, 2020

(51) Int. Cl. G09F 7/20; E05B 1/00

(52) U.S. Cl. CPC G09F 7/20; G09F 2007/1813; E05B 1/0015

(57) ABSTRACT

An adjustable mount, including a front portion, including a handle receiving groove disposed along at least a portion of a length of the front portion to receive at least a portion of at least one door handle therein, and a rear portion removably connected to the front portion to mount the front portion and the rear portion to a door pull.

### BACKGROUND

### 1. Field

The present general inventive concept relates generally to a mount, and particularly, to an adjustable and configurable mount.

### 2. Description of the Related Art

Shopping malls, office buildings, businesses, hospitals, gymnasiums, universities, schools, and other non-residential, and even residential-type edifices, often include doors that are designed to require door pulls as door-opening mechanisms. A conventional door pull may be installed either on both sides of a door, or on one side of a door with a different alternative door-opening mechanism on the other side of the door, such as a push plate, door handle, or touch bar.

The conventional door pull may be difficult to grip due to having a smooth and/or round surface. During an emergency situation, such as a fire, the conventional door pull may prevent a quick exit, when time is of the essence.

Moreover, other door pulls have a fixed mount. The fixed mount limits how a handle can be connected because the fixed mount is usually oriented in one direction and/or connected on a fixed portion of the door pull. During renovation projects, a consumer, customer, or user may seek to change the handles on every door to match new specifications. Unfortunately, the fixed mount may require a new door pull or an entire new door to be constructed that wastes both time and money.

Therefore, there is a need for adjustable mounts that allow a consumer to easily install and/or arrange mounts based on the consumer's preferences and/or requirements.

### SUMMARY

The present general inventive concept provides an adjustable and configurable mount.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable mount, including a front portion, including a handle receiving groove disposed along at least a portion of a length of the front portion to receive at least a portion of at least one door handle therein, and a rear portion removably connected to the front portion to mount the front portion and the rear portion to a door pull.

The front portion may further include a first elevated surface perpendicularly disposed on an end of the front portion away from a rear surface with respect to a first direction, a second elevated surface disposed on at least a portion of the front portion a distance away from the first elevated surface, and a pull receiving portion concavely disposed between the first elevated surface and the second elevated surface to receive at least a portion of the door pull therein.

The first elevated surface and the second elevated surface may each include at least one fastener receiving aperture.

The rear portion may include a first end, including at least one fastener connecting aperture, a second end, including at least one other fastener connecting aperture, and a plurality of set fasteners to be inserted through the at least one fastener connecting aperture and the at least one other fastener connecting aperture into each at least one fastener receiving aperture to prevent the front portion and the rear portion from moving along the door pull in response to tightening the plurality of set fasteners, and to facilitate movement of the front portion and the rear portion along the door pull in response to extracting the plurality of set fasteners.

The rear portion may further include another pull receiving portion concavely disposed between the first end and the second end to receive at least a portion of the door pull therein.

The handle receiving groove may facilitate movement of the at least one door handle in at least one of a first lateral direction and a second lateral direction.

The foregoing and/or other features and utilities of the present general inventive concept may also be achieved by providing a ladder pull mount, including a front portion, including a handle receiving groove disposed along at least a portion of a length of the front portion to receive at least a portion of at least one door handle therein, and a pull receiving portion concavely disposed between a first end of the front portion and the handle receiving groove, a rear portion removably connected to the front portion to mount the front portion and the rear portion to a door pull, the rear portion including a first end, a second end, and another pull receiving portion concavely disposed between the first end and the second end, and a shim removably inserted between the pull receiving portion and the another pull receiving portion to receive at least a portion of the door pull therein.

The front portion may further include a first elevated surface perpendicularly disposed on an end of the front portion to extend away from a rear surface with respect to a first direction, and a second elevated surface disposed on at least a portion of the front portion a distance away from the first elevated surface to extend away from the rear surface with respect to the first direction.

The first elevated surface and the second elevated surface may each include at least one fastener receiving aperture.

The first end and the second end may each include at least one fastener connecting aperture.

The rear portion may include a plurality of set fasteners to be inserted through each at least one fastener connecting aperture into each at least one fastener receiving aperture to prevent the front portion and the rear portion from moving along the door pull in response to tightening the plurality of set fasteners, and to facilitate movement of the front portion and the rear portion along the door pull in response to extracting the plurality of set fasteners.

The shim may include a first portion, a second portion removably disposed on a bottom surface of the first portion, and a pull receiving aperture disposed between the first portion and the second portion.

The pull receiving aperture may have a diameter of 0.75 inches.

The pull receiving aperture may have a diameter of one inch.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates an isometric front view of at least one adjustable mount disposed in a separate pull configuration on at least one door pull, according to an exemplary embodiment of the present general inventive concept;

FIG. 1B illustrates an isometric front view of the at least one adjustable mount disposed in the separate pull configuration on the at least one door pull, according to an exemplary embodiment of the present general inventive concept;

FIG. 2A illustrates an isometric front view of the at least one adjustable mount disposed in a split pull configuration on the at least one door pull, according to an exemplary embodiment of the present general inventive concept;

FIG. 2B illustrates an isometric front view of the at least one adjustable mount disposed in the split pull configuration on the at least one door pull, according to an exemplary embodiment of the present general inventive concept;

FIG. 3A illustrates a side perspective rear view of a front portion of the at least one adjustable mount, according to an exemplary embodiment of the present general inventive concept;

FIG. 3B illustrates a rear view of the front portion of the at least one adjustable mount, according to an exemplary embodiment of the present general inventive concept;

FIG. 3C illustrates a sectional view taken along C-C of FIG. 3B of the front portion of the at least one adjustable mount, according to an exemplary embodiment of the present general inventive concept;

FIG. 4A illustrates a side perspective rear view of a rear portion of the at least one adjustable mount, according to an exemplary embodiment of the present general inventive concept;

FIG. 4B illustrates a rear view of the rear portion of the at least one adjustable mount, according to an exemplary embodiment of the present general inventive concept;

FIG. 4C illustrates a sectional view taken along B-B of FIG. 4B of the rear portion of the at least one adjustable mount, according to an exemplary embodiment of the present general inventive concept;

FIG. 5 illustrates an isometric rear view of at least one ladder pull mount, according to another exemplary embodiment of the present general inventive concept;

FIG. 6 illustrates an exploded view of the at least one ladder pull mount, according to another exemplary embodiment of the present general inventive concept; and

FIG. 7 illustrates an isometric view of a shim, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components

Adjustable Mount 1000
Front Portion 1100
First Elevated Surface 1110
First Fastener Receiving Aperture 1111
Second Fastener Receiving Aperture 1112
Second Elevated Surface 1120
Third Fastener Receiving Aperture 1121
Fourth Fastener Receiving Aperture 1122
Pull Receiving Portion 1130
Handle Receiving Groove 1140
Rear Portion 1200
First End 1210
First Fastener Connecting Aperture 1211
Second Fastener Connecting Aperture 1212
Second End 1220
Third Fastener Connecting Aperture 1221
Fourth Fastener Connecting Aperture 1222
Pull Receiving Portion 1230
Set Fasteners 1240
Ladder Pull Mount 2000
Front Portion 2100
First Elevated Surface 2110
First Fastener Receiving Aperture 2111
Second Elevated Surface 2120
Second Fastener Receiving Aperture 2121
Pull Receiving Portion 2130
Handle Receiving Groove 2140
Rear Portion 2200
First End 2210
First Fastener Connecting Aperture 2211
Second End 2220
Second Fastener Connecting Aperture 2221
Pull Receiving Portion 2230
Set Fasteners 2240
Shim 2300
First Portion 2310
Second Portion 2320
Pull Receiving Aperture 2330
Shim 3300
First Portion 3310
Second Portion 3320
Pull Receiving Aperture 3330

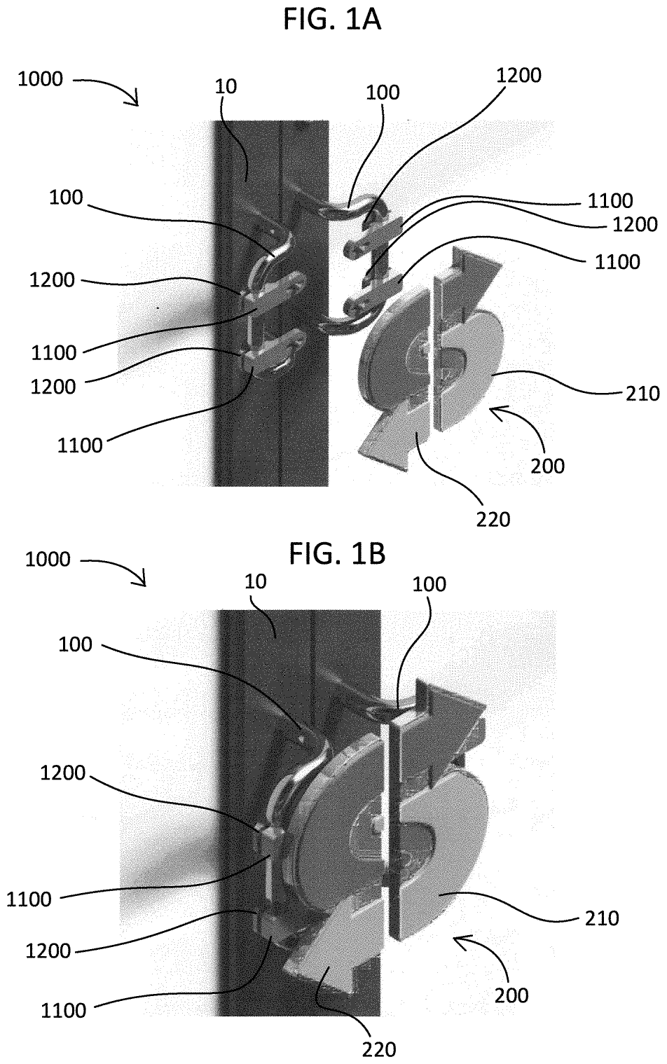

FIG. 1A illustrates an isometric front view of at least one adjustable mount 1000 disposed in a separate pull configuration on at least one door pull 100, according to an exemplary embodiment of the present general inventive concept.

FIG. 1B illustrates an isometric front view of the at least one adjustable mount 1000 disposed in the separate pull configuration on the at least one door pull 100, according to an exemplary embodiment of the present general inventive concept.

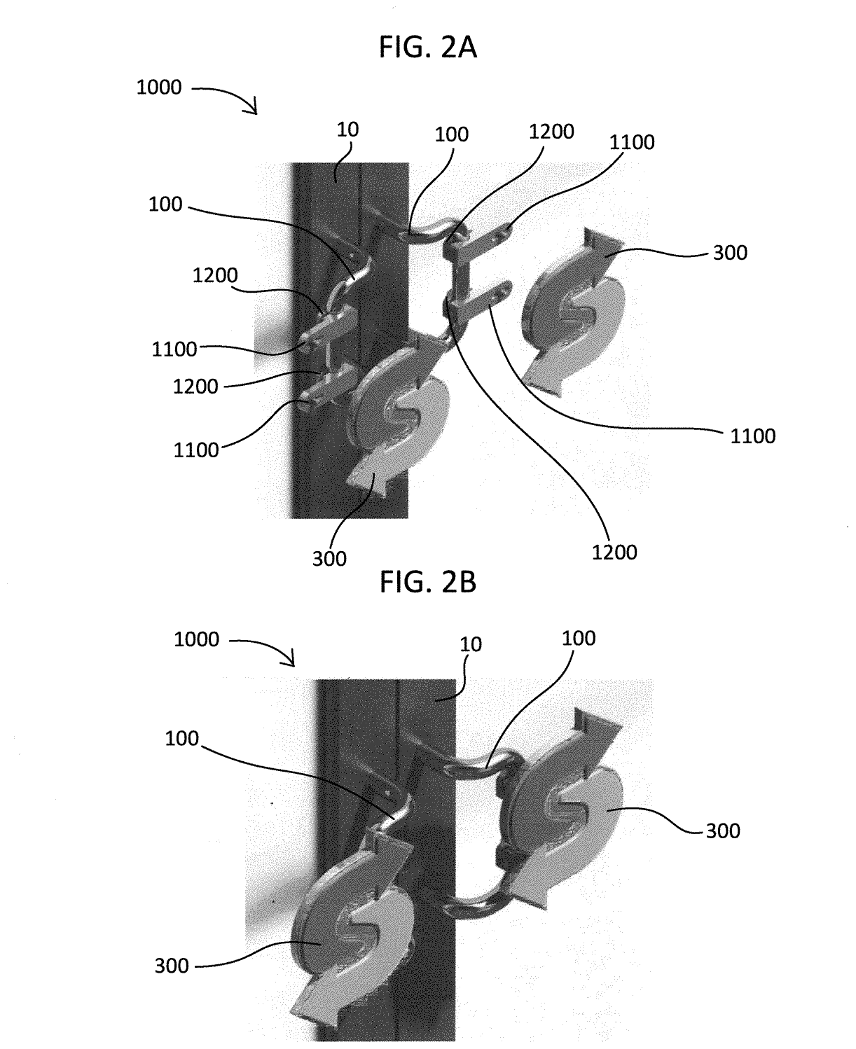

FIG. 2A illustrates an isometric front view of the at least one adjustable mount 1000 disposed in a split pull configuration on the at least one door pull 100, according to an exemplary embodiment of the present general inventive concept.

FIG. 2B illustrates an isometric front view of the at least one adjustable mount 1000 disposed in the split pull configuration on the at least one door pull 100, according to an exemplary embodiment of the present general inventive concept.

The at least one adjustable mount 1000 may be constructed from at least one of metal, plastic, wood, ceramic, and rubber, etc., but is not limited thereto. Also, the at least one adjustable mount 1000 may have a low profile to minimize standoff height with respect to a door 10. In other words, the at least one adjustable mount 1000 may facilitate gripping the at least one door pull 100.

Referring to FIGS. 1A through 2B, the at least one adjustable mount 1000 may include a front portion 1100 and a rear portion 1200, but is not limited thereto.

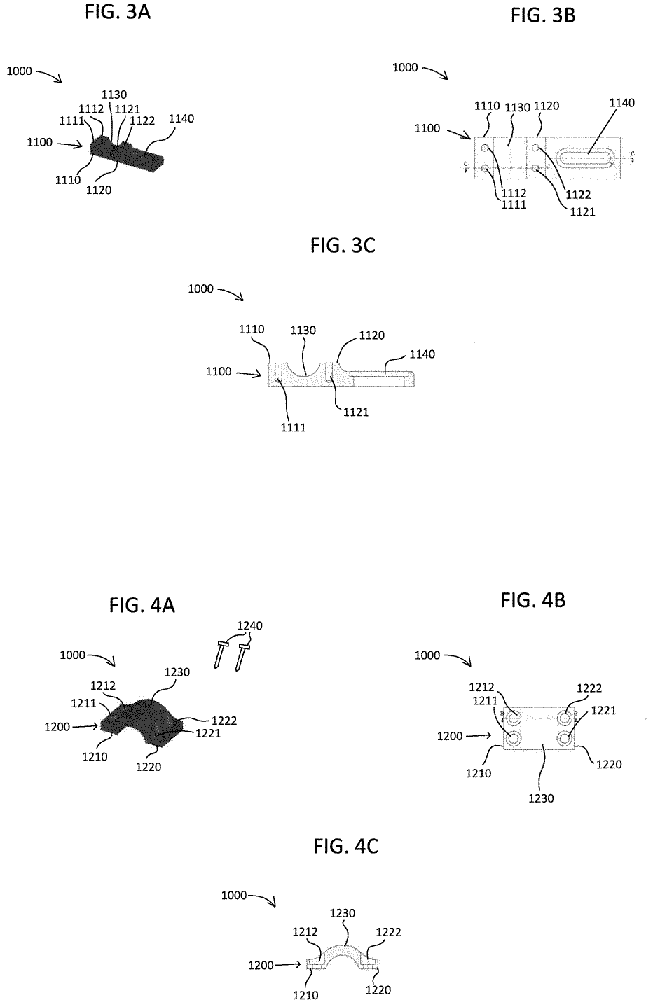

FIG. 3A illustrates a side perspective rear view of a front portion 1100 of the at least one adjustable mount 1000, according to an exemplary embodiment of the present general inventive concept.

FIG. 3B illustrates a rear view of the front portion 1100 of the at least one adjustable mount 1000, according to an exemplary embodiment of the present general inventive concept.

FIG. 3C illustrates a sectional view taken along C-C of FIG. 3B of the front portion 1100 of the at least one adjustable mount 1000, according to an exemplary embodiment of the present general inventive concept.

Referring to FIGS. 3A through 3C, the front portion 1100 may include a first elevated surface 1110, a second elevated surface 1120, a pull receiving portion 1130, and a handle receiving groove 1140, but is not limited thereto.

The first elevated surface 1110 may be perpendicularly disposed on an end of the front portion 1100 away from a rear surface of the front portion 1100 with respect to a first direction. Additionally, the second elevated surface 1120 may be perpendicularly disposed away from the rear surface of the front portion 1100 with respect to the first direction, such that the second elevated surface 1120 may be disposed on at least a portion of the rear surface of the front portion 1100 a distance away from the first elevated surface 1110. Moreover, the first elevated surface 1110 may be in parallel with the second elevated surface 1120.

The first elevated surface 1110 may include a first fastener receiving aperture 1111 and a second fastener receiving aperture 1112, but is not limited thereto.

The second elevated surface 1120 may include a third fastener receiving aperture 1121 and a fourth fastener receiving aperture 1122, but is not limited thereto.

The pull receiving portion 1130 may be concavely disposed between the first elevated surface 1110 and the second elevated surface 1120.

Referring to FIGS. 1A through 3C, the pull receiving portion 1130 is illustrated to be concave. However, the pull receiving portion 1130 may be constructed to have any shape and/or size to accommodate any size and/or shape of the door pull 100. For example, the pull receiving portion 1130 may be orthogonally shaped to receive an orthogonally shaped door pull 100. As such, the rear surface of the front portion 1100 may be disposed on the door pull 100, such that the pull receiving portion 1130 may receive at least a portion of the door pull 100 therein.

The handle receiving groove 1140 may be disposed along at least a portion of a length of the front portion 1100. Additionally, the handle receiving groove 1140 may also be a handle receiving aperture 1140.

Referring to FIGS. 1A and 1B, the handle receiving groove 1140 may receive at least a portion of a split handle 200 therein. More specifically, a first half 210 or a second half 220 of the split handle 200 may be removably connected to the handle receiving groove 1140 of the front portion 1100. Also, the second half 220 or the first half 210 may be removably connected to another handle receiving groove 1140 of another front portion 1100. Moreover, the split handle 200 may be moved in a first lateral direction (i.e. left) or a second lateral direction (i.e. right) within the handle receiving groove 1140, such that the split handle 200 may be positioned based on a preference of a user.

Referring to FIGS. 2A and 2B, the handle receiving groove 1140 may receive at least a portion of at least one separate handle 300 therein. More specifically, the at least one separate handle 300 may be removably connected to the handle receiving groove 1140 of the front portion 1100. Moreover, the at least one separate handle 300 may be moved in the first lateral direction or the second lateral direction within the handle receiving groove 1140, such that the at least one separate handle 300 may be positioned based on the preference of the user.

FIG. 4A illustrates a side perspective rear view of a rear portion 1200 of the at least one adjustable mount 1000, according to an exemplary embodiment of the present general inventive concept.

FIG. 4B illustrates a rear view of the rear portion 1200 of the at least one adjustable mount 1000, according to an exemplary embodiment of the present general inventive concept.

FIG. 4C illustrates a sectional view taken along B-B of FIG. 4B of the rear portion 1200 of the at least one adjustable mount 1000, according to an exemplary embodiment of the present general inventive concept.

Referring to FIGS. 4A through 4C, the rear portion 1200 may include a first end 1210, a second end 1220, a pull receiving portion 1230, and a plurality of set fasteners 1240, but is not limited thereto.

The first end 1210 may include a first fastener connecting aperture 1211 and a second fastener connecting aperture 1212, but is not limited thereto.

The second end 1220 may include a third fastener connecting aperture 1221 and a fourth fastener connecting aperture 1222, but is not limited thereto.

The pull receiving portion 1230 may be concavely disposed between the first end 1210 and the second end 1220.

Referring to FIGS. 1A through 3C, the pull receiving portion 1230 is illustrated to be concave. However, the pull receiving portion 1230 may be constructed to have any shape and/or size to accommodate any size and/or shape of the door pull 100. For example, the pull receiving portion 1230 may be orthogonally shaped to receive an orthogonally shaped door pull 100. As such, a front surface of the rear portion 1200 may be disposed on the door pull 100, such that the pull receiving portion 1230 may receive at least a portion of the door pull 100 therein.

Furthermore, the rear portion 1200 may be aligned to correspond to the front portion 1100. More specifically, the first fastener connecting aperture 1211, the second fastener connecting aperture 1212, the third fastener connecting aperture 1221, and the fourth fastener connecting aperture 1222 (collectively, the connecting apertures) may be disposed on the front portion 1100 to correspond to the first fastener receiving aperture 1111, the second fastener receiving aperture 1112, the third fastener receiving aperture 1121, and the fourth fastener receiving aperture 1122 (collectively, the receiving apertures), respectively.

Each of the plurality of set fasteners 1240 may include a twine, a string, a rope, a magnet, a clasp, a hook, a screw, a nail, a bolt, a nut, a washer, and/or any combination thereof, but is not limited thereto.

A first of the plurality of set fasteners 1240 may be inserted through the first fastener connecting aperture 1211 to connect to the first fastener receiving aperture 1111. A second of the plurality of set fasteners 1240 may be inserted through the second fastener connecting aperture 1212 to connect to the second fastener receiving aperture 1112. A third of the plurality of set fasteners 1240 may be inserted through the third fastener connecting aperture 1221 to connect to the third fastener receiving aperture 1121. A fourth of the plurality of set fasteners 1240 may be inserted through the fourth fastener connecting aperture 1222 to connect to the fourth fastener receiving aperture 1122.

As such, the plurality of set fasteners 1240 may prevent the front portion 1100 and/or the rear portion 1200 from moving along the door pull 100 in response to being inserted (i.e. tightened) thereto. Specifically, the plurality of set fasteners 1240 may be rotated in a first direction (i.e. clockwise) or a second direction (i.e. counterclockwise) to move each of the plurality of set fasteners 1240 into the connecting apertures and/or the receiving apertures. In other words, the rear portion 1200 may removably connect to the front portion 1100 to mount the front portion 1100 and/or the rear portion 1200 to the door pull 100.

Conversely, the front portion 1100 and/or the rear portion 1200 may move in response to extracting (i.e. loosening) at least one of the plurality of set fasteners 1240 from any of the aforementioned apertures, as described above. As such, the at least one adjustable mount 1000 may be moved in a first vertical direction (i.e. up) or a second vertical direction (i.e. down) in response to extracting at least one of the plurality of set fasteners 1240.

Therefore, the at least one adjustable mount 1000 may facilitate adjusting a location and/or position of the at least one separate handle 300 and/or the split handle 200 to the door pull 100. Furthermore, the at least one adjustable mount 1000 may facilitate opening the door 10 by connecting the at least one separate handle 300 and/or the split handle 200 to the door 10.

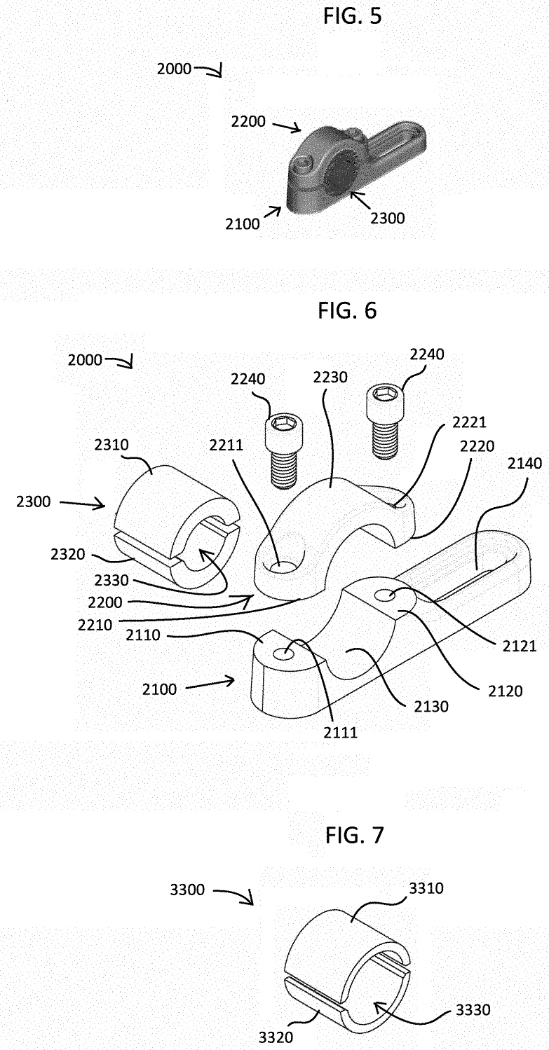

FIG. 5 illustrates an isometric rear view of at least one ladder pull mount 2000, according to another exemplary embodiment of the present general inventive concept.

FIG. 6 illustrates an exploded view of the at least one ladder pull mount 2000, according to another exemplary embodiment of the present general inventive concept.

The at least one ladder pull mount 2000 may be constructed from at least one of metal, plastic, wood, ceramic, and rubber, etc., but is not limited thereto. Also, the at least one adjustable mount 2000 may have a low profile to minimize standoff height with respect to the door 10. The at least one ladder pull mount 2000 may apply to the door 10 and/or the door pull 100 as described above with respect to FIGS. 1A through 2B. In other words, the at least one ladder pull mount 2000 may facilitate gripping the at least one door pull 100.

Referring to FIGS. 5 and 6, the at least one ladder pull mount 2000 may include a front portion 2100, a rear portion 2200, and a shim 2300, but is not limited thereto.

The front portion 2100 may include a first elevated surface 2110, a second elevated surface 2120, a pull receiving portion 2130, and a handle receiving groove 2140, but is not limited thereto.

The first elevated surface 2110 may be perpendicularly disposed on an end of the front portion 2100 to extend away from a rear surface of the front portion 2100 with respect to a first direction. Additionally, the second elevated surface 2120 may be perpendicularly disposed away from the rear surface of the front portion 2100 to extend away from the rear surface of the front portion with respect to the first direction, such that the second elevated surface 2120 may be disposed on at least a portion of the rear surface of the front portion 2100 a distance away from the first elevated surface 2110. Moreover, the first elevated surface 2110 may be in parallel with the second elevated surface 2120.

The first elevated surface 2110 may include a first fastener receiving aperture 2111, but is not limited thereto.

The second elevated surface 2120 may include a second fastener receiving aperture 2121, but is not limited thereto.

The pull receiving portion 2130 may be concavely disposed between the first elevated surface 2110 and the second elevated surface 2120.

Referring to FIG. 6, the pull receiving portion 2130 is illustrated to be concave. However, the pull receiving portion 2130 may be constructed to have any shape and/or size to accommodate any size and/or shape of the door pull 100. For example, the pull receiving portion 2130 may be orthogonally shaped to receive an orthogonally shaped door pull 100. As such, the rear surface of the front portion 2100 may be disposed on the door pull 100, such that the pull receiving portion 2130 may receive at least a portion of the door pull 100 therein.

The handle receiving groove 2140 may be disposed along at least a portion of a length of the front portion 2100. Additionally, the handle receiving groove 2140 may also be a handle receiving aperture 2140.

Referring again to FIG. 6, the handle receiving groove 2140 may receive at least a portion of a split handle 200 therein. More specifically, a first half 210 or a second half 220 of the split handle 200 may be removably connected to the handle receiving groove 2140 of the front portion 2100. Also, the second half 220 or the first half 210 may be removably connected to another handle receiving groove 2140 of another front portion 2100. Moreover, the split handle 200 may be moved in a first lateral direction (i.e. left) or a second lateral direction (i.e. right) within the handle receiving groove 2140, such that the split handle 200 may be positioned based on a preference of a user.

Referring again to FIG. 6, the handle receiving groove 2140 may receive at least a portion of at least one separate handle 300 therein. More specifically, the at least one separate handle 300 may be removably connected to the handle receiving groove 2140 of the front portion 2100. Moreover, the at least one separate handle 300 may be moved in the first lateral direction or the second lateral direction within the handle receiving groove 2140, such that the at least one separate handle 300 may be positioned based on the preference of the user.

The rear portion 2200 may include a first end 2210, a second end 2220, a pull receiving portion 2230, and a plurality of set fasteners 2240, but is not limited thereto.

The first end 2210 may include a first fastener connecting aperture 2211, but is not limited thereto.

The second end 2220 may include a second fastener connecting aperture 2221, but is not limited thereto.

The pull receiving portion 2230 may be concavely disposed between the first end 2210 and the second end 2220.

Referring again to FIG. 6, the pull receiving portion 2230 is illustrated to be concave. However, the pull receiving portion 2230 may be constructed to have any shape and/or size to accommodate any size and/or shape of the door pull 100. For example, the pull receiving portion 2230 may be orthogonally shaped to receive an orthogonally shaped door pull 100. As such, a front surface of the rear portion 2200 may be disposed on the door pull 100, such that the pull receiving portion 2230 may receive at least a portion of the door pull 100 therein.

Furthermore, the rear portion 2200 may be aligned to correspond to the front portion 2100. More specifically, the first fastener connecting aperture 2211 and the second fastener connecting aperture 2221 (collectively, the connecting apertures) may be disposed on the front portion 2100 to correspond to the first fastener receiving aperture 2111 and the second fastener receiving aperture 2121 (collectively, the receiving apertures), respectively.

Each of the plurality of set fasteners 2240 may include a twine, a string, a rope, a magnet, a clasp, a hook, a screw, a nail, a bolt, a nut, a washer, and/or any combination thereof, but is not limited thereto.

A first of the plurality of set fasteners 2240 may be inserted through the first fastener connecting aperture 2211 to connect to the first fastener receiving aperture 2111. A second of the plurality of set fasteners 2240 may be inserted through the second fastener connecting aperture 2221 to connect to the second fastener receiving aperture 2121.

As such, the plurality of set fasteners 2240 may prevent the front portion 2100 and/or the rear portion 2200 from moving along the door pull 100 in response to being inserted (i.e. tightened) thereto. Specifically, the plurality of set fasteners 2240 may be rotated in a first direction (i.e. clockwise) or a second direction (i.e. counterclockwise) to move each of the plurality of set fasteners 2240 into the connecting apertures and/or the receiving apertures. In other words, the rear portion 2200 may removably connect to the front portion 2100 to mount the front portion 2100 and/or the rear portion 2200 to the door pull 100.

Conversely, the front portion 2100 and/or the rear portion 2200 may move in response to extracting (i.e. loosening) at least one of the plurality of set fasteners 2240 from any of the aforementioned apertures, as described above. As such, the at least one ladder pull mount 2000 may be moved in a first vertical direction (i.e. up) or a second vertical direction (i.e. down) in response to extracting at least one of the plurality of set fasteners 2240.

The shim 2300 may include a first portion 2310, a second portion 2320, and a pull receiving aperture 2330, but is not limited thereto.

Referring again to FIGS. 5 and 6, the shim 2300 may be removably inserted between the pull receiving portion 2130 of the front portion 2100 and the pull receiving portion 2230 of the rear portion 2200. A first end of the first portion 2310 may be removably disposed on a top surface of a first end of the second portion 2320. Similarly, a second end of the first portion 2310 may be removably disposed on a top surface of a second end of the second portion 2320. In other words, the first end of the second portion 2320 may be removably disposed on a bottom surface of the first end of the first portion 2310, and the second end of the second portion 2320 may be removably disposed on a bottom surface of the second end of the first portion 2310.

As such, collectively, the first portion 2310 and the second portion 2320 form the pull receiving aperture 2330 therebetween.

Referring again to FIGS. 5 and 6, the pull receiving aperture 2330 is illustrated to be circular. However, the pull receiving aperture 2330 may be constructed to have any shape and/or size to accommodate any size and/or shape of the door pull 100. For example, the pull receiving aperture 2330 may have a diameter of 0.75 inches for the door pull 100 having a similar diameter, such that the pull receiving portion 2130 and the pull receiving portion 2230 may not fit around the door pull 100 without the shim 2300 being inserted therebetween. As another example, the pull receiving aperture 2330 may be orthogonally shaped to receive an orthogonally shaped door pull 100. As such, the pull receiving aperture 2330 may be disposed on the door pull 100, such that the pull receiving aperture 2330 may receive at least a portion of the door pull 100 therein.

Furthermore, the shim 2300 may at least partially deform in response to contacting at least a portion of the door pull 100, such that the shim 2300 may snugly fit the door pull 100.

As such, the shim 2300 may be used to adjust an ability of the at least one ladder pull mount 2000 to be mounted to the door pull 100.

Therefore, the at least one adjustable mount 2000 may facilitate adjusting a location and/or position of the at least one separate handle 300 and/or the split handle 200 to the door pull 100. Furthermore, the at least one adjustable mount 2000 may facilitate opening the door 10 by connecting the at least one separate handle 300 and/or the split handle 200 to the door 10.

FIG. 7 illustrates an isometric view of a shim 3300, according to another exemplary embodiment of the present general inventive concept.

The shim 3300 may include a first portion 3310, a second portion 3320, and a pull receiving aperture 3330, but is not limited thereto.

The shim 3300 may be used in the at least one ladder pull mount 2000 as described above with respect to the shim 2300. In other words, the shim 3300 may provide similar functions as the shim 2300.

Referring to FIGS. 5 through 7, the shim 3300 may be removably inserted between the pull receiving portion 2130 of the front portion 2100 and the pull receiving portion 2230 of the rear portion 2200. A first end of the first portion 3310 may be removably disposed on a top surface of a first end of the second portion 3320. Similarly, a second end of the first portion 3310 may be removably disposed on a top surface of a second end of the second portion 3320. In other words, the first end of the second portion 3320 may be removably disposed on a bottom surface of the first end of the first portion 3310, and the second end of the second portion 3320 may be removably disposed on a bottom surface of the second end of the first portion 3310.

As such, collectively, the first portion 3310 and the second portion 3320 form the pull receiving aperture 3330 therebetween.

Referring again to FIGS. 5 through 7, the pull receiving aperture 3330 is illustrated to be circular. However, the pull receiving aperture 3330 may be constructed to have any shape and/or size to accommodate any size and/or shape of the door pull 100. For example, the pull receiving aperture 3330 may have a diameter of one inch for the door pull 100 having a similar diameter, such that the pull receiving portion 2130 and the pull receiving portion 2230 may not fit around the door pull 100 without the shim 3300 being inserted therebetween. As another example, the pull receiving aperture 3330 may be orthogonally shaped to receive an orthogonally shaped door pull 100. As such, the pull receiving aperture 3330 may be disposed on the door pull 100, such that the pull receiving aperture 3330 may receive at least a portion of the door pull 100 therein.

Furthermore, the shim 3300 may at least partially deform in response to contacting at least a portion of the door pull 100, such that the shim 3300 may snugly fit the door pull 100.

As such, the shim 3300 may be used to adjust an ability of the at least one ladder pull mount 2000 to be mounted to the door pull 100.

The present general inventive concept may include an adjustable mount 1000, including a front portion 1100, including a handle receiving groove 1140 disposed along at least a portion of a length of the front portion 1100 to receive at least a portion of at least one door handle therein, and a rear portion 1200 removably connected to the front portion 1100 to mount the front portion 1100 and the rear portion 1200 to a door pull 100.

The front portion 1100 may further include a first elevated surface 1110 perpendicularly disposed on an end of the front portion 1100 away from a rear surface with respect to a first direction, a second elevated surface 1120 disposed on at least a portion of the front portion 1100 a distance away from the first elevated surface 1110, and a pull receiving portion 1130 concavely disposed between the first elevated surface 1110 and the second elevated surface 1120 to receive at least a portion of the door pull 100 therein.

The first elevated surface 1110 and the second elevated surface 1110 may each include at least one fastener receiving aperture.

The rear portion 1200 may include a first end 1210, including at least one fastener connecting aperture, a second end 1220, including at least one other fastener connecting aperture, and a plurality of set fasteners 1240 to be inserted through the at least one fastener connecting aperture and the at least one other fastener connecting aperture into each at least one fastener receiving aperture to prevent the front portion 1100 and the rear portion 1200 from moving along the door pull 100 in response to tightening the plurality of set fasteners 1240, and to facilitate movement of the front portion 1100 and the rear portion 1200 along the door pull 100 in response to extracting the plurality of set fasteners 1240.

The rear portion 1200 may further include another pull receiving portion 1230 concavely disposed between the first end 1210 and the second end 1220 to receive at least a portion of the door pull 100 therein.

The handle receiving groove 1140 may facilitate movement of the at least one door handle in at least one of a first lateral direction and a second lateral direction.

The present general inventive concept may also include a ladder pull mount 2000, including a front portion 2100, including a handle receiving groove 2140 disposed along at least a portion of a length of the front portion 2100 to receive at least a portion of at least one door handle therein, and a pull receiving portion 2130 concavely disposed between a first end of the front portion 2100 and the handle receiving groove 2140, a rear portion 2200 removably connected to the front portion 2100 to mount the front portion 2100 and the rear portion 2200 to a door pull 100, the rear portion 2200 including a first end 2210, a second end 2220, and another pull receiving portion 2230 concavely disposed between the first end 2210 and the second end 2220, and a shim 2300 removably inserted between the pull receiving portion 2130 and the another pull receiving portion 2230 to receive at least a portion of the door pull 100 therein.

The front portion 2100 may further include a first elevated surface 2110 perpendicularly disposed on an end of the front portion 2100 to extend away from a rear surface with respect to a first direction, and a second elevated surface 2120 disposed on at least a portion of the front portion 2100 a distance away from the first elevated surface 2110 to extend away from the rear surface with respect to the first direction.

The first elevated surface 2110 and the second elevated surface 2120 may each include at least one fastener receiving aperture.

The first end 2210 and the second end 2220 may each include at least one fastener connecting aperture.

The rear portion 2200 may include a plurality of set fasteners 2240 to be inserted through each at least one fastener connecting aperture into each at least one fastener receiving aperture to prevent the front portion 2100 and the rear portion 2200 from moving along the door pull 100 in response to tightening the plurality of set fasteners 2240, and to facilitate movement of the front portion 2100 and the rear portion 2200 along the door pull 100 in response to extracting the plurality of set fasteners 2240.

The shim 2300 may include a first portion 2310, a second portion 2320 removably disposed on a bottom surface of the first portion 2310, and a pull receiving aperture 2330 disposed between the first portion 2310 and the second portion 2320.

The pull receiving aperture 2330 may have a diameter of 0.75 inches.

The pull receiving aperture 2330 may have a diameter of one inch.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An adjustable mount, comprising:
a front portion, comprising:
a handle receiving groove disposed along at least a portion of a length of the front portion to receive at least a portion of at least one door handle therein; and
a rear portion removably connected to the front portion to mount the front portion and the rear portion to a door pull.

2. The adjustable mount of claim 1, wherein the front portion further comprises:
a first elevated surface perpendicularly disposed on an end of the front portion away from a rear surface with respect to a first direction;
a second elevated surface disposed on at least a portion of the front portion a distance away from the first elevated surface; and
a pull receiving portion concavely disposed between the first elevated surface and the second elevated surface to receive at least a portion of the door pull therein.

3. The adjustable mount of claim 2, wherein the first elevated surface and the second elevated surface, each comprise:
at least one fastener receiving aperture.

4. The adjustable mount of claim 3, wherein the rear portion comprises:
a first end, comprising:
at least one fastener connecting aperture;
a second end, comprising:
at least one other fastener connecting aperture; and
a plurality of set fasteners to be inserted through the at least one fastener connecting aperture and the at least one other fastener connecting aperture into each at least one fastener receiving aperture to prevent the front portion and the rear portion from moving along the door pull in response to tightening the plurality of set fasteners, and to facilitate movement of the front portion and the rear portion along the door pull in response to extracting the plurality of set fasteners.

5. The adjustable mount of claim 4, wherein the rear portion further comprises:
another pull receiving portion concavely disposed between the first end and the second end to receive at least a portion of the door pull therein.

6. The adjustable mount of claim 1, wherein the handle receiving groove facilitates movement of the at least one door handle in at least one of a first lateral direction and a second lateral direction.

7. A ladder pull mount, comprising:
a front portion, comprising:
a handle receiving groove disposed along at least a portion of a length of the front portion to receive at least a portion of at least one door handle therein, and
a pull receiving portion concavely disposed between a first end of the front portion and the handle receiving groove;
a rear portion removably connected to the front portion to mount the front portion and the rear portion to a door pull, the rear portion comprising:
a first end,
a second end, and
another pull receiving portion concavely disposed between the first end and the second end; and
a shim removably inserted between the pull receiving portion and the another pull receiving portion to receive at least a portion of the door pull therein.

8. The ladder pull mount of claim 7, wherein the front portion further comprises:
a first elevated surface perpendicularly disposed on an end of the front portion to extend away from a rear surface with respect to a first direction; and
a second elevated surface disposed on at least a portion of the front portion a distance away from the first elevated surface to extend away from the rear surface with respect to the first direction.

9. The ladder pull mount of claim 8, wherein the first elevated surface and the second elevated surface, each comprise:
at least one fastener receiving aperture.

10. The ladder pull mount of claim 9, wherein the first end and the second end, each comprise:
at least one fastener connecting aperture.

11. The ladder pull mount of claim 10, wherein the rear portion comprises:
a plurality of set fasteners to be inserted through each at least one fastener connecting aperture into each at least one fastener receiving aperture to prevent the front portion and the rear portion from moving along the door pull in response to tightening the plurality of set fasteners, and to facilitate movement of the front portion and the rear portion along the door pull in response to extracting the plurality of set fasteners.

12. The ladder pull mount of claim 7, wherein the shim comprises:
a first portion;
a second portion removably disposed on a bottom surface of the first portion; and
a pull receiving aperture disposed between the first portion and the second portion.

13. The ladder pull mount of claim 12, wherein the pull receiving aperture has a diameter of 0.75 inches.

14. The ladder pull mount of claim 12, wherein the pull receiving aperture has a diameter of one inch.
